(19) United States
(12) Patent Application Publication
(10) Pub. No.: US 2025/0306219 A1
(43) Pub. Date: Oct. 2, 2025

(54) RADIATION IMAGING APPARATUS

(71) Applicant: CANON KABUSHIKI KAISHA, Tokyo (JP)

(72) Inventors: HIDETOMO SUWA, Tokyo (JP); MASATAKA SUZUKI, Kanagawa (JP); MOTOKI TAGAWA, Kanagawa (JP); TAKAHIRO YAMAMOTO, Kanagawa (JP); SATOMI KYOGOKU, Kanagawa (JP)

(21) Appl. No.: 19/088,190

(22) Filed: Mar. 24, 2025

(30) Foreign Application Priority Data
Mar. 26, 2024 (JP) 2024-050587

(51) Int. Cl. G01T 1/20

(52) U.S. Cl. CPC G01T 1/20188

(57) ABSTRACT

A radiation imaging apparatus includes a radiation detecting panel that detects radiation, and a casing that houses the radiation detecting panel and including a front portion where the radiation is incident on the radiation detecting panel and a rear portion opposite to the front portion, wherein the rear portion includes a holding portion indented toward the front portion, wherein the holding portion includes a predetermined holding region extending along a predetermined side when an outer perimeter of the rear portion is viewed as a quadrilateral shape, and wherein the predetermined holding region has a greater indentation depth at a position closer to a center of the predetermined side than to an end portion of the predetermined side than at a position closer to the end portion than to the center.

### BACKGROUND

### Field

The present disclosure relates to a radiation imaging apparatus. The radiation imaging apparatus (a radiographic image capturing apparatus, a radiation detecting apparatus, a medical device) can be used in industrial non-destructive testing and medical diagnosis. The radiation imaging apparatus is, for example, a flat panel detector (FPD).

### Description of the Related Art

There has been a known radiation imaging apparatus that detects intensity distribution of radiation transmitted through a subject and generates a radiographic image of the target.

As one form of the radiation imaging apparatuses, so-called electronic cassettes, which are thin and lightweight portable apparatuses, are developed to enable rapid imaging of portions in a wide area. Particularly in recent years, wireless radiation imaging apparatuses without cable connections are developed to improve portability.

Japanese Patent Application Laid-Open No. 2022-121107 discusses a radiation imaging apparatus having recess-shaped holding portions in the rear surface of a casing, which enables finger engagement and increases the ease of holding the radiation imaging apparatus.

Since various subjects are imaged in various environments using the radiation imaging apparatus, the radiation imaging apparatus may be held and used in various ways. Thus, it is desirable to form holding portions considering positions reachable by fingers in various holding methods and improve the ease of holding the apparatus.

### SUMMARY

The present disclosure is directed to providing a radiation imaging apparatus that is easy to hold.

According to an aspect of the present disclosure, a radiation imaging apparatus includes a radiation detecting panel configured to detect radiation, and a casing configured to house the radiation detecting panel and including a front portion where the radiation is incident on the radiation detecting panel and a rear portion opposite to the front portion, wherein the rear portion includes a holding portion indented toward the front portion, wherein the holding portion includes a predetermined holding region extending along a predetermined side when an outer perimeter of the rear portion is viewed as a quadrilateral shape, and wherein the predetermined holding region has a greater indentation depth at a position closer to a center of the predetermined side than to an end portion of the predetermined side than at a position closer to the end portion than to the center.

Further features of the present disclosure will become apparent from the following description of exemplary embodiments with reference to the attached drawings.

### BRIEF DESCRIPTION OF THE DRAWINGS

FIG. 1A is a diagram illustrating a radiation imaging apparatus viewed from the incident surface according to a first exemplary embodiment. FIG. 1B is a diagram illustrating the radiation imaging apparatus viewed from the rear surface according to the first exemplary embodiment.

FIG. 2 is a diagram illustrating a configuration of the radiation imaging apparatus in an A-A cross section according to the first exemplary embodiment.

FIG. 3 is a diagram illustrating an internal configuration of the radiation imaging apparatus viewed from the rear surface according to the first exemplary embodiment.

FIG. 4 is a diagram illustrating a configuration of the radiation imaging apparatus in a B-B cross section according to the first exemplary embodiment.

FIG. 5A is a diagram illustrating a state in which fingers are engaged with a deep recess portion. FIG. 5B is a diagram illustrating a state in which fingers are engaged with shallow recess portions according to the first exemplary embodiment.

FIG. 6 is a diagram illustrating a radiation imaging apparatus viewed from the rear surface according to a second exemplary embodiment.

FIG. 7 is a diagram illustrating a radiation imaging apparatus viewed from the rear surface according to the second exemplary embodiment.

FIG. 8 is a diagram illustrating a configuration of the radiation imaging apparatus in a C-C cross section according to the second exemplary embodiment.

FIG. 9 is a diagram illustrating a radiation imaging apparatus viewed from the rear surface according to another exemplary embodiment.

FIG. 10 is a diagram illustrating a radiation imaging apparatus viewed from the rear surface according to a modified example.

FIG. 11 is a diagram illustrating a configuration of the radiation imaging apparatus in a D-D cross section according to the modified example.

FIGS. 12A, 12B, and 12C are diagrams each illustrating an example of a cross-sectional shape of a holding portion according to the other exemplary embodiment.

FIG. 13 is a diagram illustrating a configuration of a radiation imaging system according to the first exemplary embodiment.

### DESCRIPTION OF THE EMBODIMENTS

Some exemplary embodiments of the present disclosure will be described in detail below with reference to the drawings. The disclosure is not limited to the configurations described in the exemplary embodiments. Within the scope where a similar effect can be achieved, modifications, such as replacing parts of the configurations or processes with equivalent elements or omitting parts of the configurations or processes, may be made.

### [Radiation Imaging System]

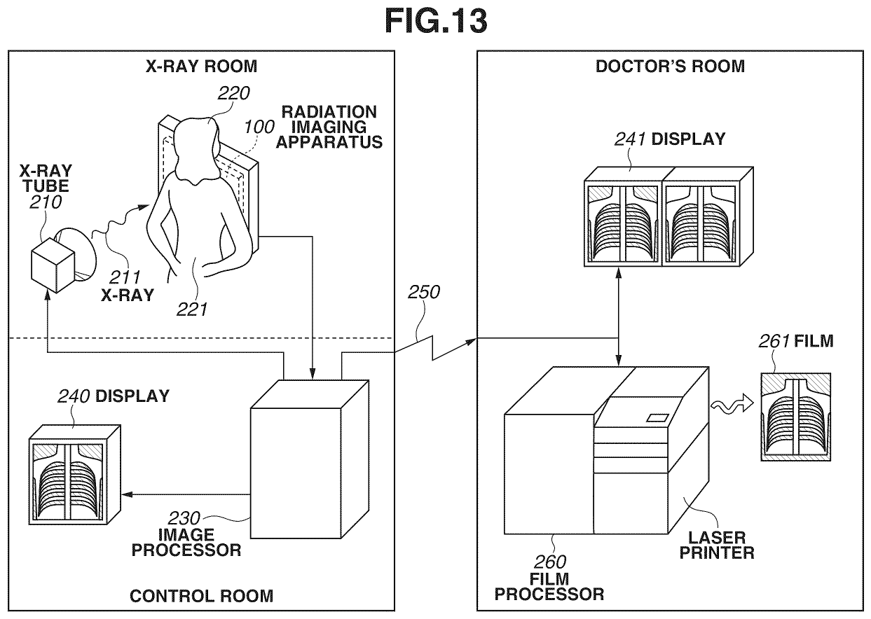

A first exemplary embodiment will now be described. FIG. 13 is a diagram illustrating a configuration of a radiation imaging system. As illustrated in FIG. 13, an X-ray 211 (radiation) generated by an X-ray tube 210 (a radiation source) passes through an imaging area 221 (a chest) of a patient 220 (a subject) to be incident on a radiation imaging apparatus 100. This incident X-ray includes information about the inside of the body of the patient 220. In response to the X-ray incidence, a scintillator (a phosphor) emits light and a sensor (a photoelectric conversion element) of a sensor panel photoelectrically converts the emitted light to obtain electrical information. The electrical information is digitized, processed by an image processor 230 (a signal processing unit), and displayed on a display 240 (a display unit). In the present specification, radiation includes X-rays, as well as α-rays, β-rays, γ-rays, particle rays and cosmic rays.

The information processed by the image processor 230 can be transferred to remote locations through a transmission processing unit 250 using networks, such as telephone lines, local area networks (LAN) or the Internet. Thus, the information processed by the image processor 230 can be displayed on a display unit (a display) 241 in a different location, e.g., a doctor's office, or stored in a recording unit, e.g., an optical disk, to enable diagnosis by a doctor at a remote site. Further, the information processed by the image processor 230 can be recorded on a film 261 by a film processor 260.

### [Radiation Imaging Apparatus]

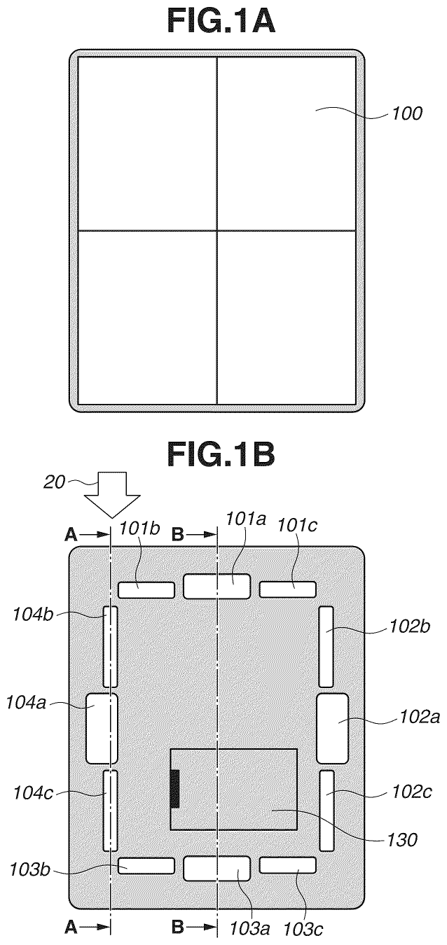

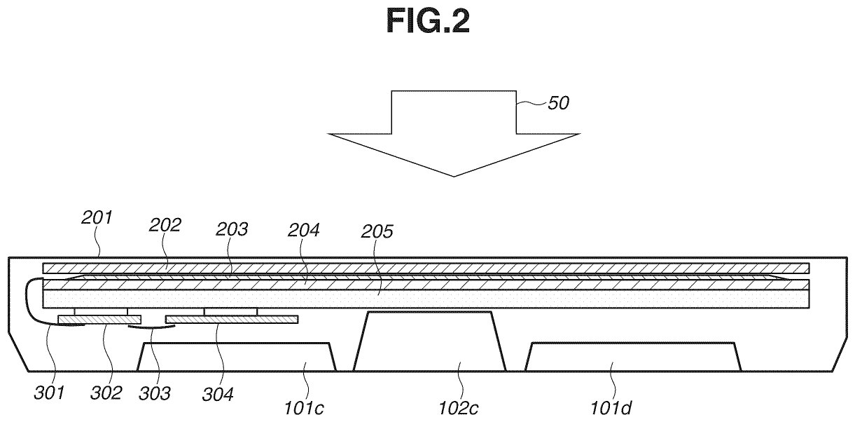

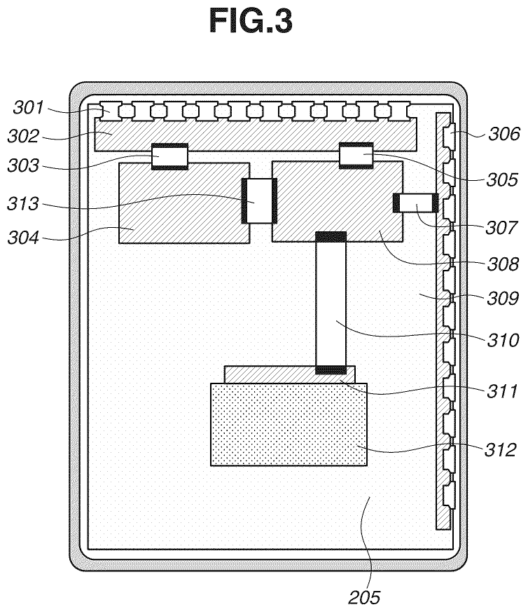

The radiation imaging apparatus 100 will be described. FIG. 1A is a diagram illustrating the radiation imaging apparatus 100 viewed from the incident surface. FIG. 1B is a diagram illustrating the radiation imaging apparatus 100 viewed from the rear surface. FIG. 2 is a diagram illustrating a configuration of the radiation imaging apparatus 100 in an A-A cross section. FIG. 3 is a diagram illustrating an internal configuration of the radiation imaging apparatus 100 viewed from the rear surface.

The radiation imaging apparatus 100 (the radiation imaging apparatus, the radiation detecting apparatus) is an apparatus for generating radiographic images based on radiation emitted by the X-ray tube 210 (the radiation source, the radiation generating apparatus). As illustrated in FIGS. 1A and 1B, the radiation imaging apparatus 100 according to the present exemplary embodiment is a flat panel detector (FPD) having a flat-plate structure.

The radiation imaging apparatus 100 includes an outer casing 201, a shock-absorbing member 202, a phosphor 203, a radiation detector 204 and a support base 205.

The outer casing 201 houses the internal structure (the internal components) of the radiation imaging apparatus 100. The outer casing 201 has strength to protect the internal components. Thus, aluminum or magnesium-based alloy materials are used for the outer casing 201. Further, a radiation incidence surface (a front portion, a radiation incidence region) of the outer casing 201 on which radiation 50 is incident has desirably high transmittance. Thus, it is desirable to use carbon fiber materials that provide both high transmittance and strength for the radiation incidence surface. Carbon fiber materials can be used in regions other than the radiation incidence region.

The radiation detector 204 is a radiation detecting panel (a radiation detecting sensor) that converts radiation into electrical signals. The radiation detector 204 according to the present exemplary embodiment is an indirect radiation detector that includes the phosphor 203 configured to convert radiation into light. Further, a direct radiation detector that converts radiation directly into electrical signals can be used.

The shock-absorbing member 202 is disposed between the outer casing 201 and the phosphor 203. The shock-absorbing member 202 absorbs external shock to protect the internal components.

The support base 205 supports the radiation detector 204 and other substrates. On the support base 205, the radiation detector 204 is fixed using bonding materials, such as adhesive tapes or adhesives.

Further, the radiation imaging apparatus 100 includes electrical substrates 302, 304, 308 and 311, a battery 312 and flexible printed circuit boards 303, 305, 307, 310 and 313.

Flexible printed circuit boards 301 are disposed between the radiation detector 204 and the electrical substrate 302 to exchange image signals. Flexible printed circuit boards 306 are disposed between the radiation detector 204 and an electrical substrate 309 to exchange drive signals. The electrical substrate 304 has a function of processing received images. The electrical substrate 308 has a function of controlling the power obtained from the battery 312 through the electrical substrate 311 and the flexible printed circuit board 310. The controlled power is supplied to electrical circuits through the flexible printed circuit boards 303, 305, 307 and 313.

### [Holding Portion]

A holding portion (a holding region, a recess portion) having a recess shape formed on the rear surface (the rear portion of the outer casing 201) of the radiation imaging apparatus 100 opposite to the radiation incidence surface of the outer casing 201 will be described in detail.

As illustrated in FIGS. 1A and 1B, recess portions 101a to 101c, 102a to 102c, 103a to 103c, and 104a to 104c for handling the radiation imaging apparatus 100 are disposed in the rear surface of the radiation imaging apparatus 100. Specifically, when the outer perimeter of the rear surface of the outer casing 201 is viewed as a quadrilateral shape, a plurality of independent recess portions extends along each side of the quadrilateral shape.

The recess portions 101a, 101b and 101c are formed to extend along a first side (a predetermined side) of the outer perimeter of the rear surface of the outer casing 201. The recess portions 102a, 102b and 102c are formed to extend along a second side of the outer perimeter of the rear surface of the outer casing 201. The recess portions 103a, 103b and 103c are formed to extend along a third side of the outer perimeter of the rear surface of the outer casing 201. The recess portions 104a, 104b and 104c are formed to extend along a fourth side of the outer perimeter of the rear surface of the outer casing 201. The second side is adjacent to the first side, and the third side is opposite to the first side. A battery storage section 130 is disposed inside a region surrounded by the plurality of recess portions.

As illustrated in FIG. 1B, the deep recess portions 101a, 102a, 103a and 104a (a first recess portions) are formed at positions near the center (positions adjacent to the center) of the sides of the outer perimeter of the rear surface of the outer casing 201. In the present exemplary embodiment, the deep recess portions 101a, 102a, 103a and 104a each have a substantially rectangular shape when viewed from the rear surface of the radiation imaging apparatus 100. The longer sides of these rectangles extend to be substantially parallel to the nearest sides of the outer perimeter of the rear surface of the outer casing 201. Further, in addition to the deep recess portions 101a, 102a, 103a and 104a, the shallow recess portions 101b, 102b, 103b and 104b and the shallow recess portions 101c, 102c, 103c and 104c (second recess portions) are formed in the rear surface of the outer casing 201. The shallow recess portions 101b, 102b, 103b and 104b and the shallow recess portions 101c, 102c, 103c and 104c each have a substantially rectangular shape when viewed from the rear surface of the radiation imaging apparatus 100. The longer sides of these rectangles extend to be substantially parallel to the nearest sides of the outer perimeter of the rear surface of the outer casing 201.

Since the relationship between a plurality of recess portions in one side is substantially the same as those of the portions in the other sides, the relationship between the recess portions 101a, 101b and 101c in the predetermined side will be described as a representative example. The recess portions 101b and 101c are disposed substantially parallel to the nearest side of the outer perimeter of the rear surface. Further, the recess portions 101b, 101c and 101a are aligned in a substantially straight line. Specifically, when the radiation imaging apparatus 100 is viewed in a direction 20 in FIG. 1B, the positional relationship between the indented region of the recess portion 101a and the indented regions of the recess portions 101b and 101c is that the indented regions at least partially overlap with each other.

### [Dimensions of Holding Portion]

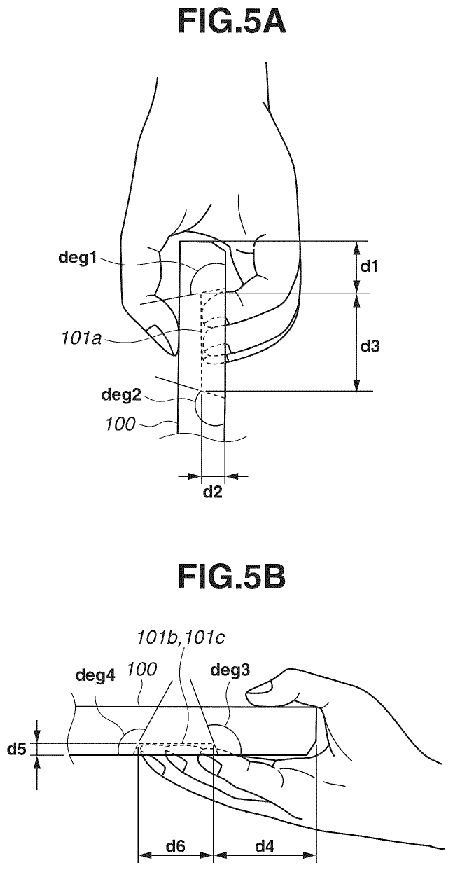

The dimensions of the holding portion will now be described in detail. FIG. 5A is a diagram illustrating a state in which fingers are engaged with a deep recess portion. FIG. 5B is a diagram illustrating a state in which fingers are engaged with shallow recess portions.

As illustrated in FIG. 5A, the radiation imaging apparatus 100 may be carried while being hung by the fingers with the radiation apparatus 100 positioned vertically. The dimensions of the deep recess portion 101a are adjusted to shape the deep recess portion 101a taking into account the foregoing carrying method. Specifically, a depth d2 of the deep recess portion 101a is set to a greater value to ensure that the load of the radiation imaging apparatus 100 is easily supported by the finger pads. On the other hand, the portions of the finger lengths used for d2 and the finger angles are considered and a distance d1 (a nearest distance) from a side edge of the outer casing 201 to the deep recess portion 101a is set to a small value. Considering the finger lengths of typical adults, it is desirable to set d1 to a value between 20 mm and 40 mm. Further, it is desirable to set d2 to 5 mm or more. The foregoing dimensions make the radiation imaging apparatus 100 easier to hold, improving portability. The width (the length in a direction perpendicular to the nearest side) of the deep recess portion 101a is greater than the widths (the lengths in the direction perpendicular to the nearest side) of the shallow recess portions 101b and 101c.

Further, desirably, the closest surface (the end portion, the finger engagement surface) to the outer perimeter of the rear surface, among the surfaces that form the deep recess portion 101a, is angled to facilitate finger engagement. Desirably, an angle deg1 between the surface and the rear surface of the outer casing 201 (the main surface of the rear portion) is set to approximately 90° to 120°. The foregoing shape allows fingers to be bent easily at the second joints to support the force in the direction of gravity due to the weight of the radiation imaging apparatus 100.

As illustrated in FIG. 5B, the radiation imaging apparatus 100 may be carried while being placed on fingers and a palm with the radiation imaging apparatus 100 positioned horizontally. FIG. 5B is a diagram illustrating how the fingers fit into the shallow recess portions.

The shallow recess portions 101b and 101c are formed on the assumption that the shallow recess portions 101b and 101c are used to hold and carry the radiation imaging apparatus 100 in a flat orientation (a horizontal orientation).

In this form, the load of the radiation imaging apparatus 100 is supported by the fingers of a user.

Thus, in order to distribute the load, it is desirable to set a distance d4 (a nearest distance) from a side edge of the outer casing 201 to the recess portions 101b and 101c to a large value. Further, when the radiation imaging apparatus 100 is held by fingers being almost fully extended while being carried horizontally, it is desirable to set a depth d5 of the recess portions 101b and 101c to a small value sufficient for the first joints of the fingers to engage with.

Considering the finger lengths of typical adults, it is desirable to set d4 to a value between 40 mm and 150 mm. Further, it is desirable to set d5 to a value less than d2. Specifically, it is desirable to set d5 to a value between 2 mm and 5 mm, inclusively (or less than 5 mm). Further, desirably, an angle deg3 between the surface engaged by fingers during carrying (the finger engagement surface), among the surfaces that form the shallow recess portions 101b and 101c and the rear surface of the outer casing 201 (the main surface of the rear portion) is set to approximately 90° to 120°. The foregoing dimensions make the radiation imaging apparatus 100 easier to hold, improving portability. Specifically, the shallowed recess portions 101b and 101c allow the finger pads to make firm contact with the rear surface of the radiation imaging apparatus 100, enabling a more stable hold. This allows an operator to carry the radiation imaging apparatus 100 more easily and safely. Further, the inclusion of the shallow recess portions 101b and 101c increases the friction caused by the fingers, facilitating horizontal pull of the radiation imaging apparatus 100. Thus, even in a case where the radiation imaging apparatus 100 is covered with a resin cover, such as a plastic bag, or the user is wearing gloves, the friction can be maintained, which results in steady operation.

### [Substrate Interference]

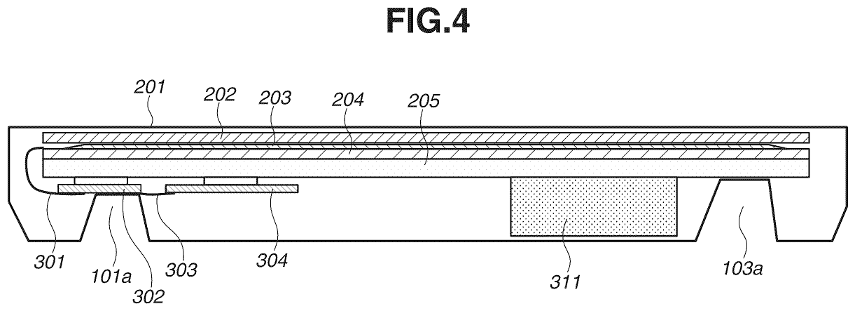

Desirably, the deep recess portions 101a, 102a, 103a, and 104a have deep indentations, as described above. However, the indentation depths may be restricted due to the layout of the internal components of the radiation imaging apparatus 100. FIG. 4 is a diagram illustrating a configuration of the radiation imaging apparatus 100 in a B-B cross section.

In FIG. 4, the recess portion 103a can be deep enough to come in contact with the support base 205 because no electrical substrates are disposed therein. It is difficult for the recess portion 101a to reach the same depth as those of the other recess portions (103a, 102a, and 104a) due to the presence of the electrical substrate 302 inside from the recess portion 101a, unlike the recess portion 103a, where no substrate is disposed therein. In this case, it is desirable not to place mounted components between the electrical substrate 302 and the recess portion 101a at the electrical substrate 302. This makes it possible to reduce the distance between the electrical substrate 302 and the recess portion 101a so that the recess portion 101a and the substrate 302 fully or nearly come into contact. This ensures a comparable indentation depth to the other recess portions (103a, 102a, and 104a). In a case where the contact between the recess portion 101a and the substrate 302 is undesirable, that can be addressed by a thin buffer material, such as a foam or rubber material, being placed between the recess portion 101a and the substrate 302.

### [Effect]

As described above, the radiation imaging apparatus 100 according to the first exemplary embodiment includes the deep recess portions 101a, 102a, 103a, and 104a and the shallow recess portions 101b, 102b, 103b, 104b, 101c, 102c, 103c, and 104c. In particular, the recess portions are formed along nearly the perimeter of the rear surface in the first exemplary embodiment. This facilitates locating portions to hold by touch, for example, when the radiation imaging apparatus 100 is held with one hand, as well as when the radiation imaging apparatus 100 is held with both hands. By accommodating the various methods of holding the radiation imaging apparatus 100, as described above, its ease of holding and operation can be improved.

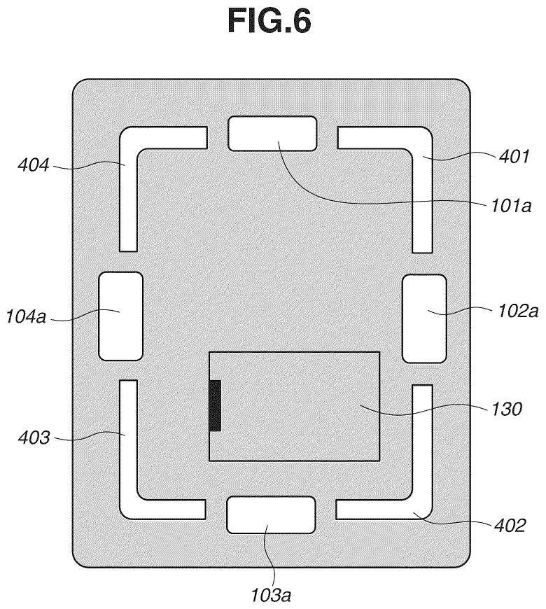

A second exemplary embodiment will now be described. In the first exemplary embodiment, an example has been described of arranging the plurality of rectangular recess portions along the outer perimeter of the rear surface of the casing. In the present exemplary embodiment, an example will be described of arranging a recess portion in a shape formed by combining a plurality of recess portions. The configurations in the present exemplary embodiment are substantially the same as those in the first exemplary embodiment, except for a configuration that defines the feature of the present exemplary embodiment. Thus, the configurations that are substantially the same are denoted by the same reference numerals, and the detailed descriptions will be omitted. FIG. 6 is a diagram illustrating a radiation imaging apparatus viewed from the rear surface.

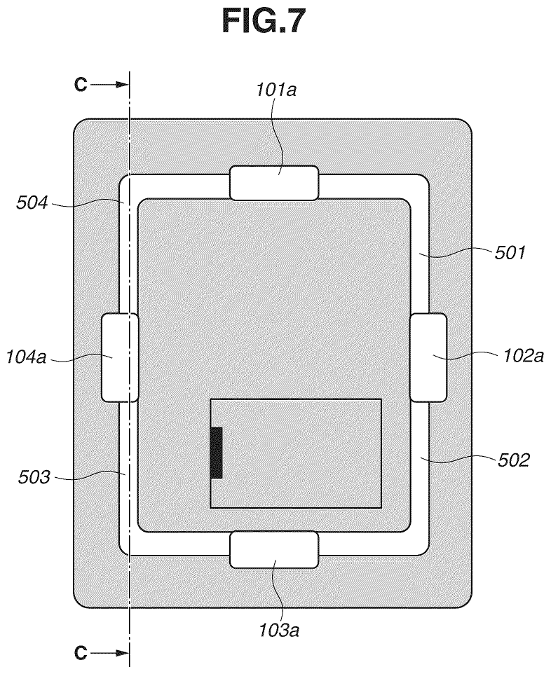

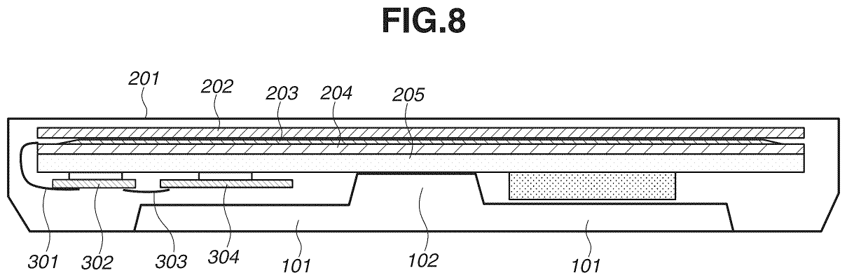

FIG. 7 is a diagram illustrating a radiation imaging apparatus viewed from the rear surface. FIG. 8 is a diagram illustrating a configuration of the radiation imaging apparatus in a C-C cross section.

In FIG. 6, the rear portion of the outer casing 201 includes shallow recess portions 401, 402, 403, and 404, in addition to the deep recess portions 101a, 102a, 103a, and 104a. The shallow recess portion 401 functions similarly to connect the recess portions 101c and 102b in the first exemplary embodiment into one. The recess portions 402, 403, and 404 having similar shapes are formed at the other corner portions.

The connected recess portions disposed near the corners, as described above, improve the ease of holding at the corner portions.

Further, as a modified example, the recess portions 101a, 102a, 103a, and 104a may be connected to the recess portions 402, 403, and 404. In FIG. 7, recess portions 501, 502, 503, and 504 connected to the recess portions 101a, 102a, 103a, and 104a are formed.

FIG. 8 is a diagram illustrating the C-C cross section shown in FIG. 7. As illustrated in FIG. 8, recess portions with different depths are connected via steps. Connecting the adjacent recess portions, as described above, allows for a smooth transition of the holding position when an operator holds the radiation imaging apparatus 100. For example, when an operator holding a longer side intends to switch to a shorter side, the holding position can be changed while the radiation imaging apparatus 100 is being held.

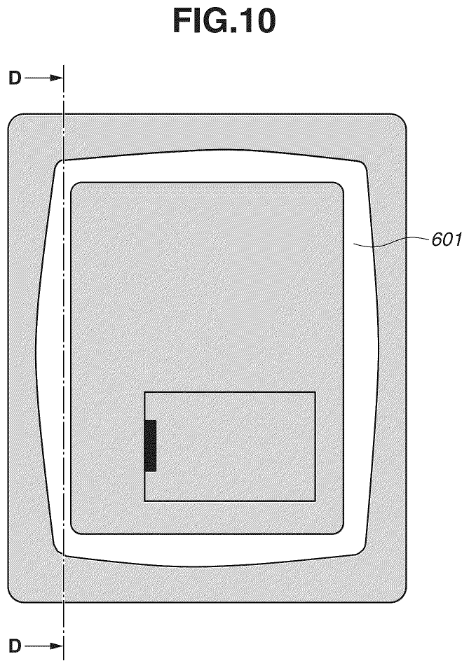

In the recess portion 610 of FIG. 10, which is another modified example, a configuration with a gradually changing depth and width, designed to eliminate steps formed at the connection points of a plurality of recess portions, can be employed. FIG. 10 is a diagram illustrating a radiation imaging apparatus viewed from the rear surface.

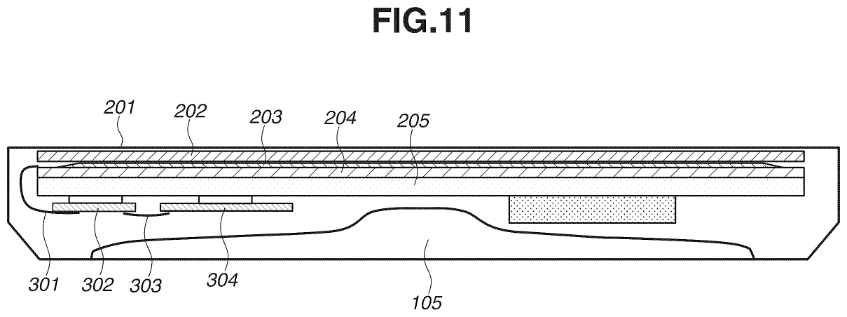

FIG. 11 is a diagram illustrating a configuration of the radiation imaging apparatus in a D-D cross section. The illustrated shape can be employed in which the depth of the recess portion, the distance from the recess portion to a side edge, and the width of the recess portion are gradually changed from positions adjacent to the center position of the outer perimeter to positions that are not adjacent. The foregoing shape further improves operability of the radiation imaging apparatus 100.

Other exemplary embodiments will now be described. The present disclosure is not limited to the above-described exemplary embodiments, and various modifications (including integrated combinations of the exemplary embodiments) may be made based on the spirit of the present disclosure and should not be excluded from the scope of the present disclosure. Specifically, the present disclosure encompasses all configurations formed by combining the above-described exemplary embodiments and their modified examples.

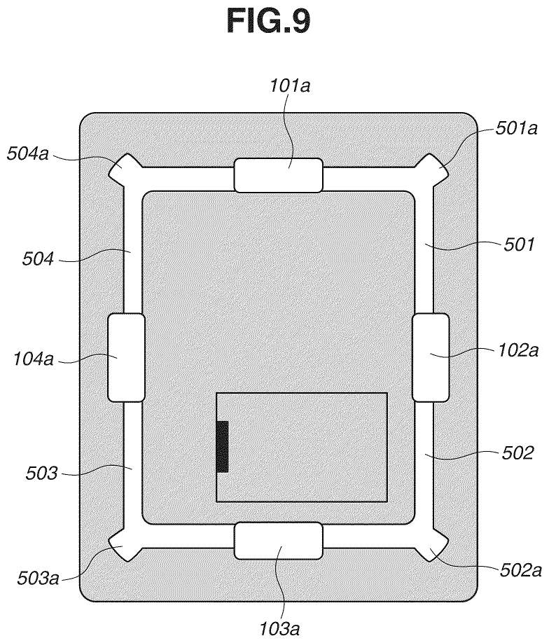

In the second exemplary embodiment, an example has been described of forming a recess portion bent at a right angle along each corner portion to form shallow recess portions near the corner portions of the rear surface of the casing. However, the recess portions formed along the corner portions may have a different shape. FIG. 9 is a diagram illustrating a radiation imaging apparatus viewed from the rear surface. In FIG. 9, corner recess portions 501a, 502a, 503a, and 504a are included in addition to the configuration illustrated in FIG. 8. The corner recess portions 501a, 502a, 503a, and 504a extending toward the corner portions of the rear surface of the casing, as described above, improve the ease of holding the corner portions of the casing. Desirably, the distance from each of the corner portions of the casing to the corresponding corner recess portion of the corner recess portions 501a, 502a, 503a, and 504a is d4.

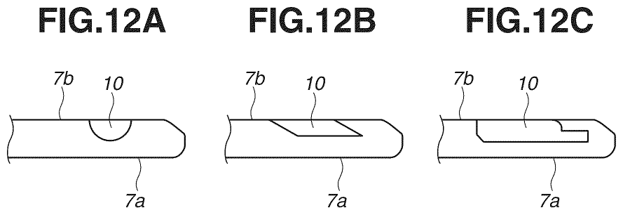

In the first and second exemplary embodiments, a configuration has been described in which the angle between the finger engagement surface and the rear surface of the outer casing 201 falls within 90° to 120°. However, the shape of the finger engagement surface in each recess portion (holding portion) may be different from those described in the first and second exemplary embodiments. FIGS. 12A, 12B, and 12C are diagrams each illustrating an example of a cross-sectional shape of a holding portion.

As illustrated in FIGS. 12A to 12C, the cross section of a recess portion can have various shapes. In FIG. 12A, the cross-sectional shape of the recess portion is semi-circular to maximize the internal volume of the radiation imaging apparatus 100. In FIG. 12B, the cross-sectional shape of the recess portion is a parallelogram, and in FIG. 12C, the cross-sectional shape of the recess portion is polygonal. In a case where the cross-sectional shape of the recess portion is as illustrated in FIG. 12B or 12C, the direction of holding force changes when the radiation imaging apparatus 100 is held substantially perpendicularly to the ground as illustrated in FIG. 12A, enabling a stable hold. It is desirable to use cross-sectional shapes that facilitate finger engagement as illustrated in FIGS. 12B and 12C for the deep recess portions 101a, 102a, 103a, and 104a. On the other hands, cross-sectional shapes that facilitate finger engagement as illustrated in FIGS. 12B and 12C may not be used for the shallow recess portions 101b, 102b, 103b, 104b, 101c, 102c, 103c, and 104c. In other words, the shallow recess portions 101b, 102b, 103b, 104b, 101c, 102c, 103c, and 104c and the deep recess portions 101a, 102a, 103a, and 104a may have different cross-sectional shapes from each other.

### APPENDIX

### [Appendix 1]

A radiation imaging apparatus including a radiation detecting panel configured to detect radiation and a casing configured to house the radiation detecting panel and including a front portion where the radiation is incident on the radiation detecting panel and a rear portion opposite to the front portion, wherein the rear portion includes a holding portion indented toward the front portion, wherein the holding portion includes a first holding region and a second holding region extending along a first side when an outer perimeter of the rear portion is viewed as a quadrilateral shape, wherein the first holding region is a region adjacent to a center position of the first side, and the second holding region is a region not adjacent to the center position of the first side, and wherein the first holding region has a greater indentation depth than that of the second holding region.

### [Appendix 2]

The radiation imaging apparatus according to appendix 1, wherein a third holding region and a fourth holding region extending along a second side adjacent to the first side are included, wherein the third holding region is a region adjacent to a center position of the second side, and the fourth holding region is a region not adjacent to the center position of the second side, and wherein the third holding region has a greater indentation depth than that of the fourth holding region.

### [Appendix 3]

The radiation imaging apparatus according to appendix 1, wherein a third holding region and a fourth holding region extending along a second side opposite to the first side are included, wherein the third holding region is a region adjacent to a center position of the second side, and the fourth holding region is a region not adjacent to the center position of the second side, and wherein the third holding region has a greater indentation depth than that of the fourth holding region.

### [Appendix 4]

The radiation imaging apparatus according to appendix 1, wherein the holding portion includes a holding region extending along a second side of the quadrilateral shape, a holding region extending along a third side of the quadrilateral shape, and a holding region extending along a fourth side of the quadrilateral shape.

### [Appendix 5]

The radiation imaging apparatus according to appendix 1, wherein the second holding region further includes a region extending along a second side adjacent to the first side.

### [Appendix 6]

The radiation imaging apparatus according to appendix 1, wherein a third holding region extending along the first side and positioned opposite to the second holding region across the first holding region is included.

### [Appendix 7]

The radiation imaging apparatus according to any one of appendices 1 to 6, wherein the first holding region has a depth of 5 mm or more, and the second holding region has a depth of 5 mm or less.

### [Appendix 8]

The radiation imaging apparatus according to any one of appendices 1 to 7, wherein an angle between a nearest end portion of the first holding region to the first side and a main surface of the rear portion falls within 90° and 120°.

### [Appendix 9]

The radiation imaging apparatus according to any one of appendices 1 to 8, wherein the first holding region and the second holding region are connected regions.

### [Appendix 10]

The radiation imaging apparatus according to any one of appendices 1 to 9, wherein the first holding region and the second holding region are independent regions.

### [Appendix 11]

A radiation imaging apparatus including a radiation detecting panel configured to detect radiation and a casing configured to house the radiation detecting panel and including a front portion where the radiation is incident on the radiation detecting panel and a rear portion opposite to the front portion, wherein the rear portion includes a holding portion indented toward the front portion, wherein the holding portion includes a first holding region and a second holding region extending along a first side when an outer perimeter of the rear portion is viewed as a quadrilateral shape, wherein the first holding region is a region adjacent to a center position of the first side, and the second holding region is a region not adjacent to the center position of the first side, and wherein the first holding region has a shorter nearest distance to the first side than a nearest distance of the second holding region to the first side.

### [Appendix 12]

The radiation imaging apparatus according to appendix 11, wherein a third holding region and a fourth holding region extending along a second side adjacent to the first side are included, wherein the third holding region is a region adjacent to a center position of the second side, and the fourth holding region is a region not adjacent to the center position of the second side, and wherein the third holding region has a shorter nearest distance to the second side than a nearest distance of the fourth holding region to the second side.

### [Appendix 13]

The radiation imaging apparatus according to appendix 11, wherein a third holding region and a fourth holding region extending along a second side opposite to the first side are included, wherein the third holding region is a region adjacent to a center position of the second side, and the fourth holding region is a region not adjacent to the center position of the second side, and wherein the third holding region has a shorter nearest distance to the second side than a nearest distance of the fourth holding region to the second side.

### [Appendix 14]

The radiation imaging apparatus according to appendix 11, wherein the holding portion includes a holding region extending along a second side of the quadrilateral shape, a holding region extending along a third side of the quadrilateral shape, and a holding region extending along a fourth side of the quadrilateral shape.

### [Appendix 15]

The radiation imaging apparatus according to appendix 11, wherein the second holding region further includes a region extending along a second side adjacent to the first side.

### [Appendix 16]

The radiation imaging apparatus according to appendix 11, wherein a third holding region extending along the first side and positioned opposite to the second holding region across the first holding region is included.

### [Appendix 17]

The radiation imaging apparatus according to any one of appendices 11 to 16, wherein the first holding region has a depth of 5 mm or more, and the second holding region has a depth of 5 mm or less.

### [Appendix 18]

The radiation imaging apparatus according to any one of appendices 11 to 17, wherein an angle between a nearest end portion of the first holding region to the first side and a main surface of the rear portion falls within 90° and 120°.

### [Appendix 19]

The radiation imaging apparatus according to any one of appendices 11 to 18, wherein the first holding region has a nearest distance of 20 mm to 40 mm to the first side.

### [Appendix 20]

The radiation imaging apparatus according to any one of appendices 11 to 19, wherein the second holding region has a nearest distance of 40 mm to 150 mm to the first side.

### [Appendix 21]

The radiation imaging apparatus according to any one of appendices 11 to 20, wherein in a direction perpendicular to the first side, the first holding region has a greater width than that of the second holding region.

### [Appendix 22]

The radiation imaging apparatus according to any one of appendices 11 to 21, wherein the first holding region and the second holding region are connected regions.

### [Appendix 23]

The radiation imaging apparatus according to any one of appendices 11 to 21, wherein the first holding region and the second holding region are independent regions.

### [Appendix 24]

A radiation imaging apparatus including a radiation detecting panel configured to detect radiation and a casing configured to house the radiation detecting panel and including a front portion where the radiation is incident on the radiation detecting panel and a rear portion opposite to the front portion, wherein the rear portion includes a holding portion indented toward the front portion, wherein the holding portion includes a predetermined holding region extending along a first side when an outer perimeter of the rear portion is viewed as a quadrilateral shape, and wherein the predetermined holding region has a shorter nearest distance to the first side at a first position adjacent to a center position of the first side than at a second position not adjacent to the center position of the first side.

### [Appendix 25]

The radiation imaging apparatus according to appendix 24, wherein the holding portion includes a holding region extending along a second side of the quadrilateral shape, a holding region extending along a third side of the quadrilateral shape, a holding region extending along a fourth side of the quadrilateral shape.

### [Appendix 26]

The radiation imaging apparatus according to appendix 24 or 25, wherein the predetermined holding region has a depth of 5 mm or more at the first position, and the predetermined holding region has a depth of 5 mm or less at the second position.

### [Appendix 27]

The radiation imaging apparatus according to any one of appendices 24 to 26, wherein an angle between a nearest end portion of the predetermined holding region to the first side and a main surface of the rear portion falls within 90° and 120°.

### [Appendix 28]

The radiation imaging apparatus according to any one of appendices 24 to 27, wherein the predetermined holding region has a nearest distance of 20 mm to 40 mm to the first side at the first position.

### [Appendix 29]

The radiation imaging apparatus according to any one of appendices 24 to 28, wherein the predetermined holding region has a nearest distance of 40 mm to 150 mm to the first side at the first position.

### [Appendix 30]

The radiation imaging apparatus according to any one of appendices 24 to 29, wherein in a direction perpendicular to the first side, the predetermined holding region has a greater width at the first position than at the second position.

### [Appendix 31]

The radiation imaging apparatus according to any one of appendices 24 to 30, wherein the predetermined holding region is a single continuous region.

### [Appendix 32]

The radiation imaging apparatus according to any one of appendices 24 to 30, wherein the predetermined holding region is a region including a combination of a plurality of independent regions.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-050587, filed Mar. 26, 2024, which is hereby incorporated by reference herein in its entirety.

What is claimed is:

1. A radiation imaging apparatus comprising:
a radiation detecting panel configured to detect radiation; and
a casing configured to house the radiation detecting panel and including a front portion where the radiation is incident on the radiation detecting panel and a rear portion opposite to the front portion,
wherein the rear portion includes a holding portion indented toward the front portion,
wherein the holding portion includes a predetermined holding region extending along a predetermined side when an outer perimeter of the rear portion is viewed as a quadrilateral shape, and
wherein the predetermined holding region has a greater indentation depth at a position closer to a center of the predetermined side than to an end portion of the predetermined side than at a position closer to the end portion than to the center.

2. The radiation imaging apparatus according to claim 1,
wherein another holding region extending along another side adjacent to the predetermined side is included, and
wherein the other holding region has a greater indentation depth at a position closer to a center of the other side than to an end portion of the other side than at a position closer to the end portion than to the center.

3. The radiation imaging apparatus according to claim 1,
wherein another holding region extending along another side opposite to the predetermined side is included, and
wherein the other holding region has a greater indentation depth at a position closer to a center of the other side than to an end portion of the other side than at a position closer to the end portion than to the center.

4. The radiation imaging apparatus according to claim 1,
wherein the predetermined side is a first side, and
wherein the holding portion includes a holding region extending along a second side of the quadrilateral shape, a holding region extending along a third side of the quadrilateral shape, and a holding region extending along a fourth side of the quadrilateral shape.

5. The radiation imaging apparatus according to claim 1, wherein the predetermined holding region has a greater indentation depth at the position closer to the center of the predetermined side than to the end portion than at a position closer to one end portion of the predetermined side than to the center and a position closer to another end portion of the predetermined side than to the center.

6. The radiation imaging apparatus according to claim 1, wherein the indentation depth of the predetermined holding region at the position closer to the center of the predetermined side than to the end portion is 5 mm or more, and the indentation depth of the predetermined holding region at the position closer to the end portion of the predetermined side than to the center is 5 mm or less.

7. The radiation imaging apparatus according to claim 1, wherein an angle between a nearest end portion of the predetermined holding region to the predetermined side and a main surface of the rear portion is between 90° and 120°.

8. The radiation imaging apparatus according to claim 1, wherein the predetermined holding region is an indentation extending continuously from the position closer to the center of the predetermined side than to the end portion to the position closer to the end portion of the predetermined side than to the center.

9. The radiation imaging apparatus according to claim 1, wherein the predetermined holding region is an indentation including a boundary portion between the position closer to the center of the predetermined side than to the end portion and the position closer to the end portion of the predetermined side than to the center.

10. A radiation imaging apparatus comprising:
a radiation detecting panel configured to detect radiation; and
a casing configured to house the radiation detecting panel and including a front portion where the radiation is incident on the radiation detecting panel and a rear portion opposite to the front portion,
wherein the rear portion includes a holding portion indented toward the front portion,
wherein the holding portion includes a predetermined holding region extending along a predetermined side when an outer perimeter of the rear portion is viewed as a quadrilateral shape, and
wherein the predetermined holding region has a shorter nearest distance to the predetermined side at a position closer to a center of the predetermined side than to an end portion of the predetermined side than at a position closer to the end portion than to the center.

11. The radiation imaging apparatus according to claim 10,
wherein another holding region extending along another side adjacent to the predetermined side is included, and
wherein the other holding region has a shorter nearest distance to the predetermined side at a position closer to a center of the other side than to an end portion of the other side than at a position closer to the end portion than to the center.

12. The radiation imaging apparatus according to claim 10,
wherein another holding region extending along another side opposite to the predetermined side is included, and
wherein the other holding region has a greater indentation depth at a position closer to a center of the other side than to an end portion of the other side than at a position closer to the end portion than to the center.

13. The radiation imaging apparatus according to claim 10,
wherein the predetermined side is a first side, and
wherein the holding portion includes a holding region extending along a second side of the quadrilateral shape, a holding region extending along a third side of the quadrilateral shape, and a holding region extending along a fourth side of the quadrilateral shape.

14. The radiation imaging apparatus according to claim 10, wherein the predetermined holding region has a shorter nearest distance to the predetermined side at the position closer to the center of the predetermined side than the end portion than at a position closer to one end portion of the predetermined side than to the center and a position closer to another end portion of the predetermined side than to the center.

15. The radiation imaging apparatus according to claim 10, wherein the predetermined holding region has a nearest distance of 20 mm to 40 mm to the predetermined side at the position closer to the center of the predetermined side than to the end portion.

16. The radiation imaging apparatus according to claim 10, wherein the predetermined holding region has a nearest distance of 40 mm to 150 mm to the predetermined side at the position closer to the end portion of the predetermined side than to the center.

17. The radiation imaging apparatus according to claim 10, wherein in a direction perpendicular to the predetermined side, the predetermined holding region has a wider width at the position closer to the center of the predetermined side than to the end portion than at the position closer to the end portion of the predetermined side than to the center.

18. The radiation imaging apparatus according to claim 10, wherein the predetermined holding region is an indentation extending continuously from the position closer to the center of the predetermined side than to the end portion to the position closer to the end portion of the predetermined side than to the center.

19. The radiation imaging apparatus according to claim 10, wherein the predetermined holding region is an indentation including a boundary portion between the position closer to the center of the predetermined side than to the end portion and the position closer to the end portion of the predetermined side than to the center.
